(19) United States
(12) Patent Application Publication
(10) Pub. No.: US 2026/0260460 A1
(43) Pub. Date: Sep. 3, 2026

(54) CLASSIFICATION SUPPORT SYSTEM, CLASSIFICATION SUPPORT METHOD, AND NON-TRANSITORY COMPUTER-READABLE MEDIUM

(71) Applicant: NEC Corporation, Tokyo (JP)

(72) Inventors: Asako FUJII, Tokyo (JP); Iori Tokuda, Tokyo (JP)

(73) Assignee: NEC Corporation, Tokyo (JP)

(21) Appl. No.: 19/541,941

(22) Filed: Feb. 17, 2026

(30) Foreign Application Priority Data
Feb. 28, 2025 (JP) 2025-031173

(51) Int. Cl. G06V 10/764

(52) U.S. Cl. CPC G06V 10/764

(57) ABSTRACT

A classification support system according to the present disclosure is a classification support system that determines a classification to which a target product belongs from among a plurality of classifications of a predetermined hierarchy in a customs classification number having a hierarchical structure, the system including at least one memory storing instructions, and at least one processor configured to execute the instructions to acquire a captured image of the target product, input the acquired captured image to a first learned model that is generated for each of a plurality of classifications included in a higher hierarchy positioned higher than the predetermined hierarchy, and outputs classification information to which a product relevant to the input captured image belongs in the predetermined hierarchy in a case where a captured image of the product is input, and output classification information in the predetermined hierarchy relevant to the input captured image.

### INCORPORATION BY REFERENCE

This application is based upon and claims the benefit of priority from Japanese patent application No. 2025-031173, filed on Feb. 28, 2025, the disclosure of which is incorporated herein in its entirety by reference.

### TECHNICAL FIELD

The present disclosure relates to a classification support system, a classification support method, and a non-transitory computer-readable medium.

### BACKGROUND ART

A technique for determining a classification number to which a product belongs has been proposed. For example, JP 2022-054527 A discloses a technique for determining information regarding a product classification of a target product. An information processing apparatus according to JP 2022-054527 A determines a classification number of a product based on first product information regarding the product. Here, the first product information is, for example, invoice information for the target product. The invoice information is an invoice number, a date, an item name, a quantity, a unit, a unit price, an amount, business partner information, and the like.

### SUMMARY

An information processing apparatus according to JP 2022-054527 A determines a classification number to which a target product belongs based on information described in a document such as an invoice. Here, the degree of explanation of the target product described in a document such as an invoice may vary depending on the creator of the document. Therefore, in a case where it is tried to determine the classification number to which the target product belongs using a document such as an invoice, there is a possibility that the determination accuracy varies.

The present disclosure has been made to solve such a problem, and an example object of the present disclosure is to provide a classification support system, a classification support method, and a non-transitory computer-readable medium capable of suppressing variation in determination accuracy of a classification number to which a product belongs.

A classification support system according to an example aspect of the present disclosure is a classification support system that determines a classification to which a target product belongs from among a plurality of classifications of a predetermined hierarchy in a customs classification number having a hierarchical structure, the classification support system including at least one memory storing instructions, and at least one processor configured to execute the instructions to acquire a captured image of the target product, input the acquired captured image to a first learned model that outputs classification information to which a product relevant to the input captured image belongs in the predetermined hierarchy in a case where a captured image of the product is input, and output classification information in the predetermined hierarchy relevant to the input captured image from the first learned model, in which the first learned model is generated for each of a plurality of classifications included in a higher hierarchy positioned higher than the predetermined hierarchy, and the at least one processor is configured to execute the instructions to input the captured image to the first learned model generated for a classification in the higher hierarchy to which the target product belongs.

A classification support method according to an example aspect of the present disclosure is a classification support method for determining a classification to which a target product belongs from among a plurality of classifications of a predetermined hierarchy in a customs classification number having a hierarchical structure, the method causing a computer to execute acquiring a captured image of the target product, inputting the acquired captured image to a first learned model that is generated for a classification in a higher hierarchy to which the target product belongs among a plurality of classifications included in a higher hierarchy positioned higher than the predetermined hierarchy, and outputs classification information to which a product relevant to the input captured image belongs in the predetermined hierarchy in a case where a captured image of the product is input, and outputting classification information in the predetermined hierarchy relevant to the input captured image from the first learned model.

A non-transitory computer-readable medium according to an example aspect of the present disclosure stores a program for determining a classification to which a target product belongs from among a plurality of classifications of a predetermined hierarchy in a customs classification number having a hierarchical structure, the program causing a computer to execute a step of acquiring a captured image of the target product, a step of inputting the acquired captured image to a first learned model that is generated for a classification in a higher hierarchy to which the target product belongs among a plurality of classifications included in a higher hierarchy positioned higher than the predetermined hierarchy, and outputs classification information to which a product relevant to the input captured image belongs in the predetermined hierarchy in a case where a captured image of the product is input, and a step of outputting classification information in the predetermined hierarchy relevant to the input captured image from the first learned model.

According to the present disclosure, it is possible to provide a classification support system, a classification support method, and a non-transitory computer-readable medium capable of suppressing variation in determination accuracy of a classification number to which a product belongs.

### BRIEF DESCRIPTION OF DRAWINGS

The above and other aspects, features, and advantages of the present disclosure will become more apparent from the following description of certain example embodiments, taken in conjunction with the accompanying drawings, in which:

FIG. 1 is a block diagram illustrating a configuration of a classification support system according to the present disclosure;

FIG. 2 is a flowchart illustrating an example of a flow of a classification support method by the classification support system;

FIG. 3 is a block diagram illustrating a configuration of the classification support system according to the present disclosure;

FIG. 4 is a block diagram illustrating a configuration of a high-level classification determination unit;

FIG. 5 is a block diagram illustrating a configuration of a low-level classification determination unit;

FIG. 6 is a block diagram illustrating a configuration of a classification assisting unit; and

FIG. 7 is a diagram illustrating a hardware configuration example of the classification support system.

### EXAMPLE EMBODIMENT

### First Example Embodiment

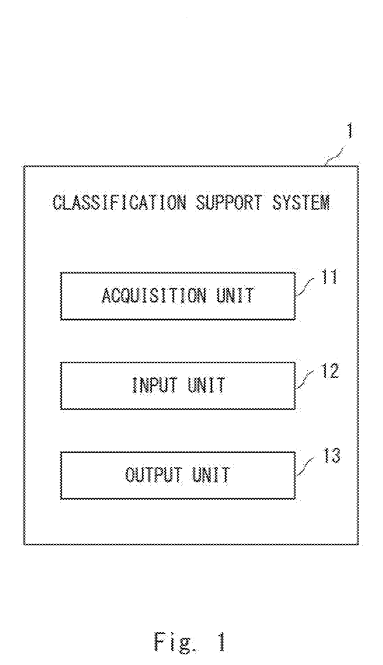

A first example embodiment according to the present disclosure will be described below with reference to the drawings. FIG. 1 is a block diagram illustrating a configuration of a classification support system 1 according to the present disclosure. The classification support system 1 is typically one or more computer apparatuses that operate in a case where a processor executes a program stored in a memory. In other words, the classification support system 1 may include one computer apparatus or two or more computer apparatuses. For example, the classification support system 1 is one or more server apparatuses.

The classification support system 1 is a system that determines a classification to which a target product belongs from among a plurality of classifications of a predetermined hierarchy in a customs classification number including a hierarchical structure. The customs classification number is also referred to as HS (Harmonized Commodity Description and Coding System) code. The customs classification number is a code defined for each attribute of products based on the “International Convention on Harmonized Commodity Description and Coding System”. The customs classification number is composed of six digits common to all countries in the world, and the first two digits are referred to as “chapter”, the first four digits are referred to as “heading”, and the first six digits are referred to as “sub-heading”. The subsequent digits of the first six digits of the customs classification number are set with different domestic subdivision numbers in each country, and in the case of Japan, these are three digits. The customs classification number may mean a number of the first six digits or may mean a number including a domestic subdivision number (nine digits in the case of Japan).

The customs classification number has a hierarchical structure such as “chapter”, “heading”, and “sub-heading”. “Chapter”, “heading”, and “sub-heading” are referred to as “hierarchy”. “Chapter” is a higher hierarchy of “heading” and “sub-heading”, and “heading” is a higher hierarchy of “sub-heading”. Similarly, “sub-heading” is a lower hierarchy of “chapter” and “heading”, and “heading” is a lower hierarchy of “chapter”. “Chapter” and “heading” may be referred to as a “parent classification” of the “heading” and the “sub-heading”. Similarly, “heading” and “sub-heading” may be referred to as “child classification” of “chapter” and “heading”. The classification of the lower hierarchy is obtained by subdividing each classification of the higher hierarchy. That is, for example, the “heading” is a plurality of classifications obtained by subdividing each “chapter”. Here, for a certain “chapter”, “heading” belonging to the lower order may be one, and for a certain “heading”, “sub-heading” belonging to the lower order may be one.

The classification support system 1 determines a classification to which a target product belongs from a plurality of classifications of a predetermined hierarchy in the customs classification number. Here, the “predetermined hierarchy” for which the classification support system 1 determines the classification is a hierarchy including another hierarchy above the predetermined hierarchy. That is, the classification support system 1 is a system that determines a classification in any lower hierarchy in the customs classification number. Specifically, the classification support system 1 determines “heading” or “sub-heading” to which the target product belongs. The classification support system 1 may determine the classification of both “heading” and “sub-heading”.

The classification support system 1 includes an acquisition unit 11, an input unit 12, and an output unit 13. The acquisition unit 11, the input unit 12, and the output unit 13 are typically software or modules in which processing is executed by the processor executing a program stored in the memory. The acquisition unit 11, the input unit 12, and the output unit 13 may be hardware such as circuits or chips. That is, the acquisition unit 11, the input unit 12, and the output unit 13 may be configured by different computer apparatuses.

At least the acquisition unit 11 and the input unit 12, the input unit 12 and a learned model to be described later, and the learned model and the output unit 13 are data-communicably connected. These data communications may be performed by wired connection or wireless connection. The data communication may be performed in the same computer apparatus, may be performed via an Internet line, or may be performed by using a near field communication technology. A type of a communication protocol in data communication is not limited.

The acquisition unit 11 acquires a captured image of a target product for which classification in a predetermined hierarchy among the customs classification numbers is to be determined. Here, the product refers to a product whose customs classification number can be determined by any method. The captured image of the product is typically an image obtained by directly capturing the product for which the customs classification number is to be determined, but the captured image is not limited thereto. For example, in a case where mass production of the target product is possible, the captured image may be an image obtained by capturing an image of another mass produced product.

In a case where the captured image of the product is input, the input unit 12 inputs the captured image acquired by the acquisition unit 11 to a learned model that outputs classification information to which the product relevant to the captured image input in the predetermined hierarchy in the customs classification number belongs. Here, the learned model may be referred to as a “first learned model”. The input unit 12 may be referred to as a “first input unit”. The classification information output by the learned model includes at least a classification number of a predetermined hierarchy determined by the learned model that the target product belongs to.

The learned model is a model generated for each of a plurality of classifications included in a higher hierarchy positioned higher than a predetermined hierarchy. For example, in a case where a “heading” of a target product is to be determined, it is assumed that “chapter” that is a higher hierarchy is classified into “chapter A”, “chapter B”, and “chapter C”. In this case, the learned model is generated for each of “chapter A”, “chapter B”, and “chapter C”. Then, the input unit 12 inputs the captured image acquired by the acquisition unit 11 to the learned model generated for the classification in the higher hierarchy to which the target product belongs. For example, in a case where the “heading” of the target product belonging to “chapter A” is to be determined, the input unit 12 inputs the captured image to the learned model generated for “chapter A”.

The learned model is a model generated by a machine learning algorithm based on a neural network (NN) such as a convolutional neural network (CNN). The learned model may be generated using a machine learning algorithm of a decision tree.

The output unit 13 outputs classification information in a predetermined hierarchy relevant to the captured image input by the input unit 12 from the learned model. The output unit 13 may be referred to as a “first output unit”. The output unit 13 outputs the classification information output by the learned model. The output unit 13 may output the classification information to a predetermined user, or may output the classification information to another computer apparatus. Here, the user whose classification information is output by the output unit 13 is, for example, a customs agent.

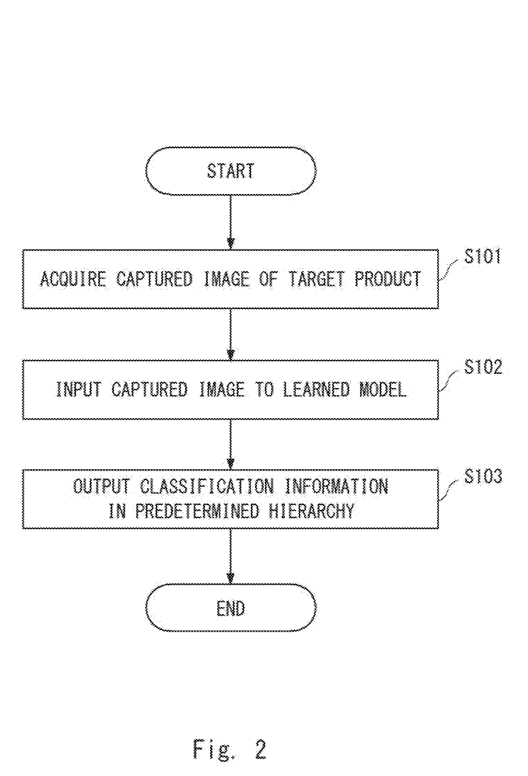

Next, a flow of a classification support method by the classification support system 1 will be described. FIG. 2 is a flowchart illustrating an example of a flow of a classification support method by the classification support system 1. First, the acquisition unit 11 acquires a captured image of a target product for which a classification in a predetermined hierarchy is to be determined (S101). Next, in a case where the captured image of the product is input, the input unit 12 inputs the captured image acquired by the acquisition unit 11 to the learned model that outputs the classification information to which the product relevant to the input captured image belongs in the predetermined hierarchy (S102). Thereafter, the output unit 13 outputs classification information in a predetermined hierarchy relevant to the captured image input by the acquisition unit 11 from the learned model (S103).

As described above, in the present example embodiment, the classification support system 1 can output the classification information to which the target product belongs in the predetermined hierarchy. Specifically, the classification support system 1 outputs the classification information by using a learned model generated by using an NN-based or decision tree-based machine learning algorithm. The learned model used by the classification support system 1 outputs classification information by inputting a captured image of a target product. As a result, the classification support system 1 can suppress variations in determination accuracy of the classification number to which the product belongs.

### Second Example Embodiment

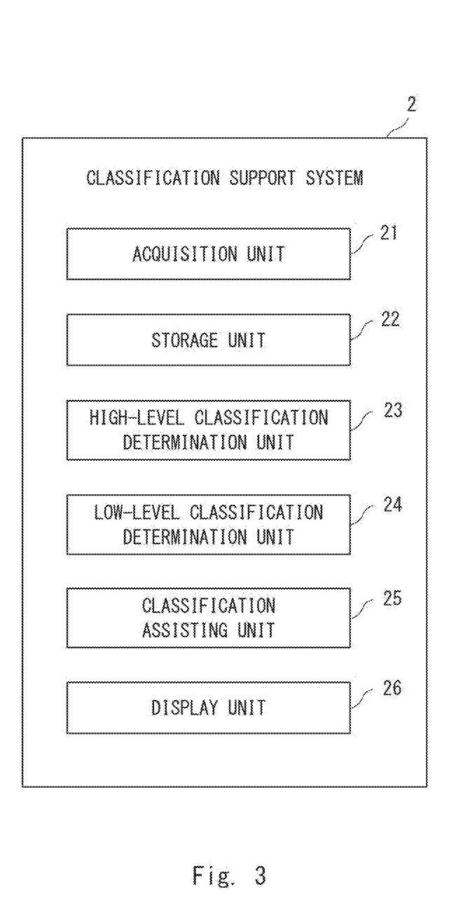

The second example embodiment is a specific example of the first example embodiment described above. FIG. 3 is a block diagram illustrating a configuration of a classification support system 2 according to the present

disclosure. The classification support system 2 includes an acquisition unit 21, a storage unit 22, a high-level classification determination unit 23, a low-level classification determination unit 24, a classification assisting unit 25, and a display unit 26. The components included in the classification support system 2 are typically software or modules in which processing is executed by the processor executing a program stored in the memory. The classification support system 2 may be hardware such as a circuitry or a chip. That is, the components of the classification support system 2 may be different computer apparatuses. For example, the classification support system 2 is one or more server apparatuses. Hereinafter, for clarity of description, description overlapping with the first example embodiment will be omitted as appropriate.

The predetermined components in the classification support system 2 are connected so as to be able to perform data communication with each other as necessary. Data communication between the components may be performed by wired connection or wireless connection. The data communication may be performed in the same computer apparatus, may be performed via an Internet line, or may be performed by using a near field communication technology. A type of a communication protocol in data communication is not limited.

The acquisition unit 21 acquires a captured image of a target product for which classification in a predetermined hierarchy among the customs classification numbers is to be determined. That is, the acquisition unit 21 is relevant to the acquisition unit 11 in the classification support system 1. The acquisition unit 21 typically acquires a captured image of a target product captured using a camera. The captured image may be a still image or a moving image. That is, the acquisition unit 21 may acquire the captured image of the target product by acquiring the frame in the moving image. The acquisition unit 11 may include a means for capturing an image of the target product. For example, the acquisition unit 11 may include a camera that captures an image of a target product.

The captured image acquired by the acquisition unit 21 is an image in which a feature of a product is represented to such an extent that a predetermined learned model can determine a classification in a predetermined hierarchy among the customs classification numbers of the target product appearing in the image. In a case where the target product can be mass-produced, the captured image may be an image showing the appearance of another mass-produced product having the same appearance as the target product. The captured image is typically an image showing the appearance of a target product. For example, in a case where the target product is imported or exported in a state where the target product is packed with a predetermined packing material, the captured image is an image showing the appearance of the target product in a state where the target product is not packed. In a case where the classification by the customs classification number is to be determined, and the feature of the target product is inside the product, the captured image acquired by the acquisition unit 21 may be an image obtained by capturing the inside of the target product.

The acquisition unit 21 acquires at least a front view, a side view, and a top view of the target product as the captured image of the target product. The acquisition unit 21 may also acquire a perspective view, a back view, and a bottom view of the target product. The acquisition unit 21 may acquire an enlarged view of a part of the target product.

The acquisition unit 21 can acquire the invoice information of the target product. The invoice information is information described in the invoice. The invoice is also referred to as “purchase slip”. The invoice information is, for example, an invoice number, a date, an item name, a quantity, a unit, a unit price, an amount, sender information, and recipient information. The acquisition unit 21 may acquire all or part of the invoice information. In this case, the acquisition unit 21 acquires the invoice information including at least the product name of the product.

The acquisition unit 21 can transmit the captured image of the target product and the invoice information of the product to the storage unit 22, the high-level classification determination unit 23, the low-level classification determination unit 24, and the classification assisting unit 25.

The storage unit 22 includes, for example, a storage apparatus such as a hard disk or a flash memory. The storage unit 22 stores the captured image of the product and the invoice information of the product acquired by the acquisition unit 21. The storage unit 22 can store the captured image of the product and the invoice information of the product in association with each other.

The storage unit 22 can store an image showing the target product of which the classification in the predetermined hierarchy is determined. In other words, the storage unit 22 can store an image showing a target product whose classification in a predetermined hierarchy is found. Specifically, the storage unit 22 can store an image showing the target product for which “chapter”, “heading”, and “sub-heading” in the customs classification number are found. Here, such an image is referred to as a “master image”. That is, the storage unit 22 can store a master image. The master image may be an image showing the target product for which “chapter” and “heading” in the customs classification number are found. The master image may be an image in which the classification of the target product is found among the captured images acquired by the acquisition unit 21, or may be an image not acquired by the acquisition unit 21. For example, the master image is an image showing the same product as the product targeted by the classification support system 2, and may be acquired by another computer apparatus. Hereinafter, the “captured image” refers to an image showing a product whose classification has not been determined in a predetermined hierarchy to be determined by the classification support system 2, and the “master image” refers to an image showing a product whose classification has been determined in a predetermined hierarchy to be determined by the classification support system 2.

The storage unit 22 can also store the classification of the product appearing in the master image. Here, the classification of the product includes a classification of a predetermined hierarchy to be determined by the classification support system 2 in the customs classification number of the product. In a case where there is a higher hierarchy with respect to the hierarchy, the classification of the product includes the classification of the higher hierarchy. That is, the storage unit 22 can store the master image, the classification of the higher hierarchy of the product, and the classification of the predetermined hierarchy in association with each other. The storage unit 22 may further associate the invoice information of the product with these pieces of information.

The storage unit 22 can store text information describing a product. The text information is information generated based on the captured image of the product acquired by the acquisition unit 21. Specifically, the text information is information describing the product appearing in the captured image from the captured image of the product acquired by the acquisition unit 21. The text information is typically text data in which the user can grasp the content, but is not limited thereto. The text information may be, for example, information expressed by a predetermined programming language. The storage unit 22 can store text information describing a product appearing in the image in association with the image stored in the storage unit 22. The storage unit 22 may store text information generated based on a captured image that is not acquired by the acquisition unit 21. For example, in a case where the storage unit 22 stores a master image received from another computer apparatus, the storage unit 22 may receive text information for the master image from the computer apparatus and store the text information.

Furthermore, the storage unit 22 can store the invoice information of the product in association with an image showing the product. The storage unit 22 can store a feature vector of an image to be stored. That is, the storage unit 22 can store a feature vector configured by a feature amount extracted from an image showing a product in association with the image.

The high-level classification determination unit 23 determines a classification to which the target product belongs from among a plurality of classifications of a higher hierarchy in the customs classification number. In other words, the high-level classification determination unit 23 determines the classification to which the target product belongs from among the plurality of classifications in the higher hierarchy. Here, the higher hierarchy is “chapter” for “heading”, and is “chapter” or “heading” for “sub-heading”. That is, the high-level classification determination unit 23 is configured to determine “chapter” in a case where the classification support system 2 intends to determine up to “heading”, and is configured to determine “chapter” or “heading” in a case where the classification support system 2 intends to determine up to “sub-heading”.

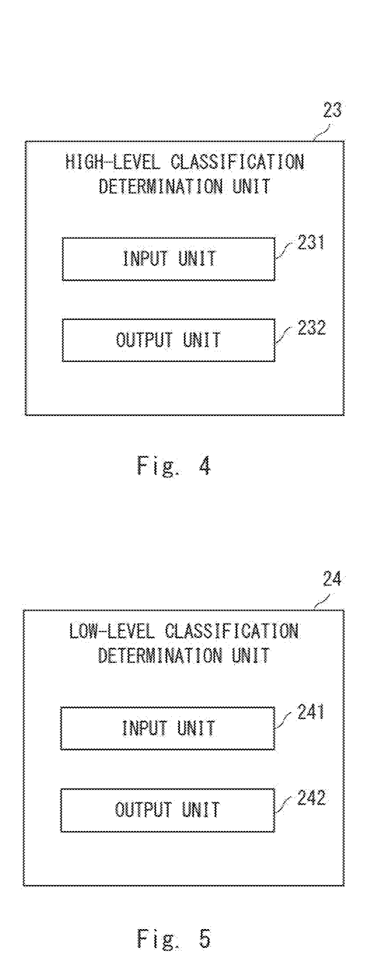

A configuration of the high-level classification determination unit 23 will be described. FIG. 4 is a block diagram illustrating a configuration of the high-level classification determination unit 23. The high-level classification determination unit 23 includes an input unit 231 and an output unit 232. The input unit 231 inputs the captured image acquired by the acquisition unit 21 to a predetermined learned model. Here, in a case where the high-level classification determination unit 23 determines the “chapter” of the target product, the learned model input by the input unit 231 may be referred to as a “chapter determination model”. Similarly, in a case where the high-level classification determination unit 23 determines a “heading”, the learned model may be referred to as a “heading determination model”. Hereinafter, the learned model used by the high-level classification determination unit 23 is referred to as a “high-level classification determination model”.

In a case where the captured image of the product is input, the high-level classification determination model outputs the classification information to which the product relevant to the input captured image belongs in the higher hierarchy. The high-level classification determination model is generated using, for example, a machine learning algorithm based on an NN such as CNN or a machine learning algorithm of a decision tree. In the case of the NN base, the high-level classification determination model includes an input layer, an output layer, and an intermediate layer. The input layer inputs a captured image of a product. The output layer outputs classification information to which a product relevant to the input captured image belongs in the higher hierarchy. In the intermediate layer, parameters are learned using teacher data in which an image showing a product is input and classification information to which the product belongs is output. In the high-level classification determination model, a captured image of a product is input to the input layer, calculation is performed in the intermediate layer, and classification information to which the product belongs is output from the output layer.

In the case of decision tree base, the machine learning algorithm may use gradient boosting, random forest, or other algorithms. In the case of the decision tree base, the high-level classification determination model has a decision tree structure in which a branch condition is learned using teacher data in which an image showing a product is an input and classification information to which the product belongs is an output. Such a high-level classification determination model is configured to input a captured image of a product to the decision tree structure and output classification information to which the product belongs by branching.

Here, the classification information to which the product belongs includes at least a classification number to which the product belongs. For example, in a case where the high-level classification determination unit 23 is to determine a “chapter” of a product, the classification information includes a number of the “chapter” to which the product specifically belongs. Here, the classification information may include information about a plurality of classifications. For example, the classification information may include a plurality of “chapter” numbers to which the high-level classification determination model determines that the product belongs. The classification information may include a certainty factor of classification by the high-level classification determination model. For example, the classification information can include a plurality of “chapter” numbers and a certainty factor by the high-level classification determination model for each “chapter”. The certainty factor of the classification may be expressed by a probability.

In addition to the captured image acquired by the acquisition unit 21, the input unit 231 can input the master image stored in the storage unit 22 to the high-level classification determination model. In this case, the high-level classification determination model compares the similarity between the captured image and the master image to output the classification information to which the product appearing in the captured image belongs. Specifically, the high-level classification determination model determines the similarity between the feature vector of the captured image and the feature vector of the master image. Here, the similarity used by the high-level classification determination model is, for example, cosine similarity. Then, the high-level classification determination model can output the classification information to which the product appearing in the master image having high similarity belongs. In this case, the high-level classification determination model can calculate the certainty factor of the classification based on the similarity to the master image.

The output unit 232 outputs the classification information in the higher hierarchy relevant to the captured image input by the input unit 231 from the high-level classification determination model. Here, in a case where the input unit 231 inputs a master image in addition to a captured image, the output unit 232 outputs classification information in a higher hierarchy relevant to the captured image and the master image. The output unit 232 can transmit the classification information to the storage unit 22, the low-level classification determination unit 24, and the display unit 26.

Returning to FIG. 3, the description of the configuration of the classification support system 2 will be continued. The low-level classification determination unit 24 determines a classification to which the target product belongs from among a plurality of classifications of a lower hierarchy with respect to a higher hierarchy in the customs classification number. That is, the low-level classification determination unit 24 determines a classification in a predetermined hierarchy determined for the target product by the classification support system 1. Specifically, the low-level classification determination unit 24 is configured to determine “heading” or “sub-heading” or both.

A configuration of the low-level classification determination unit 24 will be described. FIG. 5 is a block diagram illustrating a configuration of the low-level classification determination unit 24. The low-level classification determination unit 24 includes an input unit 241 and an output unit 242. The input unit 241 inputs the captured image acquired by the acquisition unit 21 to a predetermined learned model. The input unit 241 may be referred to as a “first input unit”. That is, the input unit 241 is relevant to the input unit 12 in the classification support system 1. The learned model input by the input unit 241 may be referred to as a “first learned model”. Hereinafter, the learned model used by the low-level classification determination unit 24 is referred to as a “first learned model”.

The first learned model is a model generated for each of a plurality of classifications included in a higher hierarchy positioned higher than a lower hierarchy for which the low-level classification determination unit 24 is to determine a classification. In other words, the first learned model is a model generated for each classification included in a higher hierarchy positioned higher than a lower hierarchy. In other words, the first learned model is a model specialized for a specific classification included in the higher hierarchy.

The first learned model may be generated for each classification included in a hierarchy one level higher than a lower hierarchy for which the low-level classification determination unit 24 is to determine the classification. For example, in a case where the low-level classification determination unit 24 is to determine a “heading” of a target product, it is assumed that “chapter” of the higher hierarchy is classified into “chapter A”, “chapter B”, and “chapter C”. In this case, the first learned model is generated for each of “chapter A”, “chapter B”, and “chapter C”. The first learned model may not be generated for each classification included in a hierarchy one level higher than the target lower hierarchy. For example, in a case where the low-level classification determination unit 24 is to determine the “sub-heading” of the target product, the first learned model used by the low-level classification determination unit 24 may be a model generated specifically for the “chapter” to which the target product belongs.

In a case where the captured image of the product is input, the first learned model outputs classification information to which the product relevant to the input captured image belongs in the lower hierarchy targeted by the low-level classification determination unit 24. The first learned model is generated using, for example, a machine learning algorithm based on an NN such as CNN or a machine learning algorithm of a decision tree. In the case of the NN base, the first learned model includes an input layer, an output layer, and an intermediate layer. The input layer inputs a captured image of a product. The output layer outputs classification information to which a product relevant to the captured image input in the lower hierarchy belongs. In the intermediate layer, parameters are learned using teacher data in which an image showing a product is input and classification information to which the product belongs is output. In the first learned model, a captured image of a product is input to the input layer, calculation is performed in the intermediate layer, and classification information to which the product belongs is output from the output layer.

In the case of decision tree base, the machine learning algorithm may use gradient boosting, random forest, or other algorithms. In the case of the decision tree base, the first learned model has a decision tree structure in which a branch condition is learned using teacher data in which an image showing a product is an input and classification information to which the product belongs in a lower hierarchy is an output. Such a first learned model is configured to input a captured image of a product to the decision tree structure and output classification information to which the product belongs by branching.

The data used as the teacher data by the first learned model is different for each classification in the higher hierarchy with respect to the lower hierarchy targeted by the low-level classification determination unit 24. For example, it is assumed that the higher hierarchy is a “chapter” and the “chapter” is classified into “chapter A”, “chapter B”, and “chapter C”. In this case, the first learned model relevant to “chapter A” uses teacher data in which an image showing a product belonging to “chapter A” is input and classification information to which the product belongs in the target lower hierarchy is output. Similarly, the first learned models relevant to “chapter B” and “chapter C” use teacher data with an image showing a product belonging to “chapter B” and “chapter C” as an input.

The first learned model outputs classification information including a classification number to which the product belongs. The classification number may be one or two or more. Here, the first learned model may determine the classification number to which the product belongs based on a predetermined threshold. That is, the first learned model can output, as the classification information, classification numbers related to one or two or more classifications that are equal to or greater than a predetermined threshold. The first learned model may output classification information for a classification that is less than a predetermined threshold.

The first learned model can output text information describing a product relevant to the input captured image as the classification information. The text information is information describing the product appearing in the captured image from the input captured image of the product. That is, the first learned model can output, as classification information, information similar to text information that can be stored in the storage unit 22.

Furthermore, the first learned model can include a certainty factor of classification by the first learned model in the classification information. Here, the certainty factor of the classification may be expressed by a probability. In a case where one or two or more classifications in which the certainty factor of the classification is equal to or greater than the predetermined threshold are output, the first learned model can output the certainty factor of each classification while including the certainty factor of each classification in the classification information in association with the one or two or more classifications. The first learned model may output the certainty factor of the classification of which the certainty factor of the classification is less than a predetermined threshold in association with the classification.

The first learned model may output the text information as the classification information in a case where the certainty factor of the classification is less than a predetermined threshold. That is, the first learned model may output the text information as the classification information in a case where the certainty factor of the classification is less than the predetermined threshold for all the classifications in the lower hierarchy of the target. In other words, in a case where there is a classification in which the certainty factor is equal to or greater than the predetermined threshold in the classification in the lower hierarchy of the target, the first learned model may not output the text information as the classification information.

The input unit 241 inputs the captured image to the relevant first learned model based on the classification information in the higher hierarchy of the target product output from the output unit 232 of the high-level classification determination unit 23. That is, the input unit 241 inputs the captured image to the first learned model generated for the classification in the higher hierarchy to which the target product belongs. For example, in a case where “chapter” that is the higher hierarchy is classified into “chapter A”, “chapter B”, and “chapter C”, in a case where the output unit 232 outputs classification information in which the higher hierarchy of the target product is “chapter A”, the output unit 232 inputs the captured image to the first learned model relevant to “chapter A”.

In addition to the captured image acquired by the acquisition unit 21, the input unit 241 can input the master image stored in the storage unit 22 to the first learned model. In this case, the first learned model outputs the classification information to which the product appearing in the captured image belongs by determining the similarity between the captured image and the master image. Here, the similarity used by the first learned model is, for example, cosine similarity. Then, the first learned model can output classification information to which a product appearing in the master image having high similarity belongs. In this case, the first learned model can calculate the certainty factor of the classification based on the similarity to the master image.

The output unit 242 outputs the classification information in the lower hierarchy relevant to the captured image input by the input unit 241 from the first classification determination model. The output unit 242 may be referred to as a “first output unit”. That is, the output unit 242 is relevant to the output unit 13 in the classification support system 1. Here, in a case where the input unit 241 inputs a master image in addition to a captured image, the output unit 242 outputs classification information in a lower hierarchy relevant to the captured image and the master image. The output unit 242 can transmit the classification information to the storage unit 22, the classification assisting unit 25, and the display unit 26.

The classification information output by the output unit 242 is classification information output by the first learned model. That is, the output unit 242 can output the classification information including the classification number to which the product belongs and the certainty factor of the classification by the first learned model. The output unit 242 can output text information relevant to the captured image input by the input unit 241. Here, in a case where the certainty factor of the classification by the first learned model is less than a predetermined threshold, the output unit 242 can output the text information as the classification information.

Returning to FIG. 3, the description of the configuration of the classification support system 2 will be continued. The classification assisting unit 25 determines a classification to which a product belongs in a predetermined hierarchy relevant to text information describing the product. Here, the predetermined hierarchy is a hierarchy targeted by the low-level classification determination unit 24. That is, the classification assisting unit 25 determines classification information in the lower hierarchy targeted by the low-level classification determination unit 24. The classification assisting unit 25 is configured to assist the low-level classification determination unit 24 in determining the classification. Specifically, the classification assisting unit 25 is configured to determine “heading” or “sub-heading” or both in the customs classification number. The low-level classification determination unit 24 uses an image classification model, whereas the classification assisting unit 25 uses a text classification model.

The classification assisting unit 25 may determine classification information in a higher hierarchy with respect to a lower hierarchy targeted by the low-level classification determination unit 24. In other words, the classification assisting unit 25 may determine the classification information in the higher hierarchy targeted by the high-level classification determination unit 23. Specifically, the classification assisting unit 25 may determine “chapter” in the customs classification number. That is, the classification assisting unit 25 may determine any customs classification number of the target product.

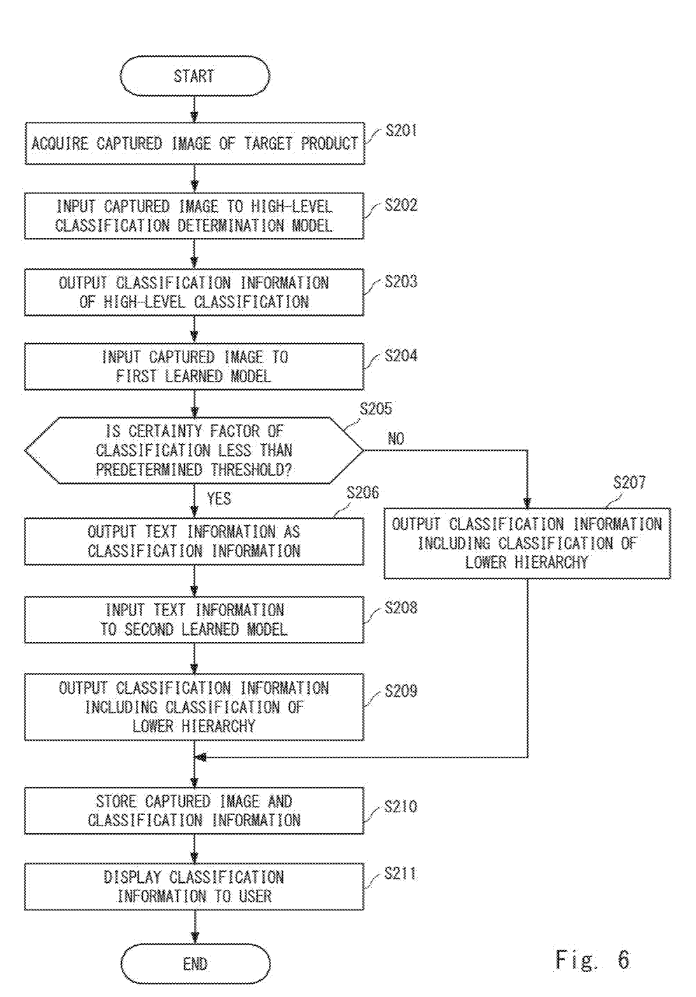

A configuration of the classification assisting unit 25 will be described. FIG. 6 is a block diagram illustrating a configuration of the classification assisting unit 25. The classification assisting unit 25 includes an input unit 251 and an output unit 252. In a case where text information describing a product is input, the input unit 251 inputs the text information output from the output unit 242 to a learned model that outputs classification information in a predetermined hierarchy relevant to the text information. The input unit 251 may be referred to as a “second input unit”. The learned model input by the input unit 251 may be referred to as a “second learned model”. Hereinafter, the learned model used by the classification assisting unit 25 is referred to as a “second learned model”. The second learned model may output any customs classification number for the product in a case where text information describing the product is input.

In a case where text information describing a target product in a hierarchy targeted by the classification assisting unit 25 is input, the second learned model outputs classification information in a predetermined hierarchy relevant to the text information. The second learned model is generated using, for example, a support vector machine (SVM), a decision tree, or a CNN machine learning algorithm. In the case of the SVM base, in the second learned model, the classification determination boundary is learned using teacher data in which text information describing a product is input and classification information to which the product belongs is output. As a result, the second learned model can input text information describing a product and output classification information to which the product belongs. The description of the second learned model in the case of using the decision tree and the CNN machine learning algorithm will be omitted. The classification information output by the second learned model is similar to the classification information output by the first learned model used by the low-level classification determination unit 24.

The input unit 251 may further input the invoice information of the product acquired by the acquisition unit 21 in addition to the text information describing the product. In a case where the invoice information is further input, the second learned model outputs the classification information based on the invoice information and the text information describing the product. That is, the second learned model outputs the classification information from the content included in the invoice information in the text information. In this case, the second learned model performs learning using teacher data including the invoice information as an input in the learning stage.

The output unit 252 outputs the classification information in the predetermined hierarchy relevant to the text information input by the input unit 251 from the second learned model. The output unit 252 may be referred to as a “second output unit”. Note that, in a case where the second learned model is to output any customs classification number for the product in a case where text information describing the product is input, the output unit 252 outputs the customs classification number.

Here, in a case where the input unit 251 inputs the invoice information in addition to the text information, the output unit 252 outputs the classification information in the predetermined hierarchy relevant to the text information and the invoice information. In a case where the second learned model is to output any customs classification number for the product in a case where text information for describing the product is input, the output unit 252 outputs the customs classification number relevant to the text information and the invoice information. The output unit 252 can transmit the classification information to the storage unit 22 and the display unit 26.

Returning to FIG. 3, the description of the configuration of the classification support system 2 will be continued. The display unit 26 is a display apparatus including a liquid crystal panel, electroluminescence, or the like. The display unit 26 may be mounted on a user terminal owned by the user. Here, the user terminal is, for example, a notebook personal computer (PC), a smartphone, and a tablet terminal. The display unit 26 can display the classification information output from the output unit 232 of the high-level classification determination unit 23, the output unit 242 of the low-level classification determination unit 24, and the output unit 252 of the classification assisting unit 25 to the user. The display unit 26 can display the captured image of the target product acquired by the acquisition unit 21. The display unit 26 can display these pieces of information in any format. For example, the display unit 26 can display the captured image and the classification information acquired by the acquisition unit 21 in association with each other.

Next, a flow of a classification support method by the classification support system 2 will be described. FIG. 6 is a flowchart illustrating an example of a flow of a classification support method by the classification support system 2. First, the acquisition unit 21 acquires a captured image of a target product (S201). Here, the acquisition unit 21 can acquire the invoice information of the target product together. Next, the input unit 231 of the high-level classification determination unit 23 inputs the captured image of the target product acquired by the acquisition unit 21 to the high-level classification determination model (S202). Here, the input unit 231 may further input the master image stored in the storage unit 22. In this case, the high-level classification determination model determines the similarity between the captured image and the master image. Thereafter, the output unit 232 outputs the classification information in the higher hierarchy relevant to the captured image input by the input unit 231 from the high-level classification determination model (S203). Here, in a case where the input unit 231 inputs a master image in addition to a captured image, the output unit 232 outputs classification information in a higher hierarchy relevant to the captured image and the master image.

Thereafter, the input unit 241 of the low-level classification determination unit 24 inputs the captured image acquired by the acquisition unit 21 to the first learned model (S204). Here, the first learned model is a model generated for the classification determined by the high-level classification determination unit 23 among the higher hierarchies positioned higher than the lower hierarchy targeted by the low-level classification determination unit 24. That is, the input unit 241 inputs the captured image acquired by the acquisition unit 21 to the first learned model generated for the classification determined by the high-level classification determination unit 23. In addition to the captured image captured by the acquisition unit 21, the input unit 241 may input the master image stored in the classification support system 2 to the first learned model.

Thereafter, the first learned model determines whether the certainty factor of the classification in the lower hierarchy is less than a predetermined threshold (S205). If YES is determined in step S205, the output unit 242 outputs text information from the first learned model as classification information (S206). Here, the output unit 242 may output the classification number of the classification less than the threshold and the certainty factor of the classification together. On the other hand, in a case where NO is determined in step S205, the output unit 242 outputs the classification number of the classification in which the certainty factor is equal to or greater than the predetermined threshold and the certainty factor of the classification as the classification information (S207). Here, the output unit 242 may further output the classification number of the classification whose certainty factor is less than the threshold and the certainty factor of the classification.

After the output unit 242 outputs the text information as the classification information in step S206, the input unit 251 of the classification assisting unit 25 inputs the text information output by the output unit 242 to the second learned model (S208). Here, the second learned model is a model for determining the same classification as the low-level classification to be determined by the low-level classification determination unit 24. The input unit 251 may further input the invoice information acquired by the acquisition unit 21 in addition to the text information. Thereafter, the output unit 252 outputs classification information relevant to the text information input by the input unit 251 from the second learned model (S209). Here, in a case where the input unit 251 inputs the invoice information in addition to the text information, the output unit 252 outputs the classification information in the predetermined hierarchy relevant to the text information and the invoice information.

Thereafter, the acquisition unit 21, the output unit 232 of the high-level classification determination unit 23, the output unit 242 of the low-level classification determination unit 24, and the output unit 252 of the classification assisting unit 25 store the captured image and the classification information in the storage unit 22 (S210). After the processing in step S207, the acquisition unit 21, the output unit 232 of the high-level classification determination unit 23, and the output unit 242 of the low-level classification determination unit 24 similarly store the captured image and the classification information in the storage unit 22. Thereafter, the display unit 26 displays the classification information to the user (S211). Here, steps S210 and S211 may be performed simultaneously, or step S211 may be performed before S210.

In this manner, the classification support system 2 can support determination of the customs classification number. That is, the classification support system 2 can determine the classification of the higher hierarchy in the customs classification number based on the learned model (high-level classification determination model) based on the captured image of the target product. Then, the classification support system 2 can determine the classification of the lower hierarchy for the higher hierarchy by using the learned model (first learned model) based on the classification information of the higher hierarchy. As a result, the classification support system 2 can determine the classifications from the higher hierarchy to the lower hierarchy in the customs classification number.

For example, in the related art, a Large Language Model (LLM) may be used to determine a customs classification number. In such a technology, the user creates text information to be input to the LLM by using the invoice information associated with the target product for which the customs classification number is desired to be determined. The LLM determines the customs classification number of the target product based on the text information created by the user. However, the text information created by the user based on the invoice information may vary depending on the user. Therefore, the determination accuracy of the customs classification number based on such text information may vary. Therefore, there is a possibility that work of creating text information using the invoice information is personalized.

The classification support system 2 can determine the customs classification number based on the captured image of the target product. That is, the classification support system 2 can determine the customs classification number using information based on the appearance or the like of the target product. Therefore, the classification support system 2 can suppress variations in the determination accuracy of the customs classification number. The classification support system 2 can output text information describing the product relevant to the captured image of the target product. That is, the classification support system 2 can create the text information by using the learned model (first learned model) instead of the user. Since the classification support system 2 can create text information independent of the user, it is possible to suppress personalization of text information creation by the user.

In a case where the certainty factor of the classification in the predetermined hierarchy based on the captured image of the target product is less than the predetermined threshold, the classification support system 2 can output the text information of the product. That is, the classification support system 2 can generate text information in a case where an appropriate classification cannot be determined based on the captured image. Therefore, for example, a user such as a customs agent can determine the classification using the text information generated in such a case.

Further, the classification support system 2 can output the classification information in the predetermined hierarchy using the text information. Therefore, the classification support system 2 can determine the classification of the product using not only the captured image of the target product but also text information describing the product. In particular, the classification support system 2 can determine the classification of the target product by using text information generated in a case where an appropriate classification cannot be determined based on the captured image. Therefore, even in a case where an appropriate classification cannot be determined from the captured image, the classification support system 2 can determine the classification of the product.

Further, the classification support system 2 can determine the classification of the product based on information included in the invoice information of the target product among the generated text information. That is, the classification support system 2 can determine the classification of the target product in consideration of the invoice information.

Further, the classification support system 2 can determine the classification of the target product by determining the similarity between the captured image of the target product for which the classification is to be determined and the master image of the product for which the classification is determined. That is, in a case where the classification of the target product is to be determined using the master image, the classification support system 2 can automatically perform the comparison between the images. Therefore, the classification support system 2 can improve convenience for the user.

Furthermore, in a case where the classification to which the target product belongs is to be determined in a predetermined hierarchy of the customs classification number, the classification support system 2 can use a learned model (first learned model) generated for each classification included in a hierarchy one level higher than the predetermined hierarchy. The classification support system 2 can acquire at least a front view, a side view, and a top view of a target product as a captured image of the target product. As a result, the classification support system 2 can determine the classification with high accuracy.

### Exemplary Hardware Configuration

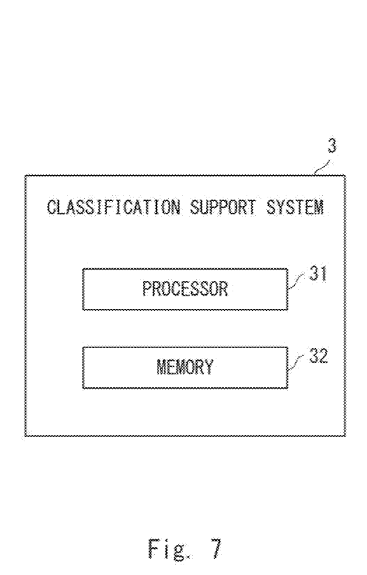

FIG. 7 is a diagram illustrating a hardware configuration example of a classification support system 3. In FIG. 7, the classification support system 3 includes a processor 31 and a memory 32. The processor 31 may be, for example, a microprocessor, a micro processing unit (MPU), or a central processing unit (CPU). The processor 31 may include a plurality of processors. The memory 32 is configured by a combination of a volatile memory and a nonvolatile memory. The memory 32 may include a storage located away from the processor 31. In this case, the processor 31 may access the memory 32 via an Input/Output (I/O) interface (not illustrated).

In the above-described example, a program can be stored and provided to a computer using any type of non-transitory computer readable media. Non-transitory computer readable media include any type of tangible storage media. Examples of non-transitory computer readable media include magnetic storage medium (for example, magneto-optical disk), CD-ROM (compact disc read only memory), CD-R (compact disc recordable), CD-R/W (compact disc rewritable), and semiconductor memory (for example, mask ROM, programmable ROM (PROM), erasable PROM (EPROM), flash ROM, and RAM). The program may be provided to a computer using any type of transitory computer readable media. Examples of transitory computer readable media include electrical signals, optical signals, and electromagnetic waves. Transitory computer readable media can provide the program to a computer via a wired communication line such as an electric wire and an optical fiber or a wireless communication line. The computer includes various information processing devices such as a PC, a server, a CPU, an MPU, a field programmable gate array (FPGA), and an application specific integrated circuit (ASIC).

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Some or all of the above-described example embodiments may also be described as the following supplementary notes, but are not limited to the following supplementary notes.

### Supplementary Note 1

A classification support system that determines a classification to which a target product belongs from among a plurality of classifications of a predetermined hierarchy in a customs classification number having a hierarchical structure, the classification support system including:

an acquisition unit that acquires a captured image of the target product;

a first input unit that inputs, in a case where a captured image of a product is input, the captured image acquired by the acquisition unit to a first learned model that outputs classification information to which a product relevant to the input captured image belongs in the predetermined hierarchy; and

a first output unit that outputs classification information in the predetermined hierarchy relevant to the captured image input by the first input unit from the first learned model, in which

the first learned model is generated for each of a plurality of classifications included in a higher hierarchy positioned higher than the predetermined hierarchy, and

the first input unit inputs the captured image to the first learned model generated for a classification in the higher hierarchy to which the target product belongs.

### Supplementary Note 2

The classification support system according to Supplementary Note 1, in which

the first learned model outputs text information describing a product relevant to the input captured image as the classification information, and

the first output unit outputs the text information as classification information in the predetermined hierarchy relevant to the captured image input by the first input unit.

### Supplementary Note 3

The classification support system according to Supplementary Note 2, in which the first output unit outputs the text information as the classification information in a case where a certainty factor of classification in the predetermined hierarchy relevant to the captured image is less than a predetermined threshold.

### Supplementary Note 4

The classification support system according to Supplementary Note 2 or 3, further including:

a second input unit that inputs text information output from the first output unit to a second learned model that outputs a customs classification number for a product in a case where the text information describing the product is input; and

a second output unit that outputs, from the second learned model, a customs classification number relevant to the text information input by the second input unit.

### Supplementary Note 5

The classification support system according to Supplementary Note 4, in which

the acquisition unit acquires invoice information of the target product, and

the second learned model is included in the invoice information, and outputs a customs classification number for a product in a case where text information describing the product is input.

### Supplementary Note 6

The classification support system according to any one of Supplementary Notes 1 to 5, further including a storage unit that stores a master image in which a target product of which a classification of the predetermined hierarchy is determined appears, and a classification of a higher hierarchy of the target product and a classification of the predetermined hierarchy in association with each other, in which

the first input unit further inputs the master image to the first learned model that outputs classification information of the predetermined hierarchy of the target product by determining similarity between the captured image acquired by the acquisition unit and the master image belonging to a classification of a higher hierarchy of the target product appearing in the captured image, and

the first output unit outputs classification information of the predetermined hierarchy relevant to the captured image input by the first input unit and the master image.

### Supplementary Note 7

The classification support system according to any one of Supplementary Notes 1 to 6, in which the first learned model is generated for each classification included in a hierarchy one level higher than the predetermined hierarchy for which the classification is to be determined.

### Supplementary Note 8

The classification support system according to any one of Supplementary Notes 1 to 7, in which the acquisition unit acquires at least a front view, a side view, and a top view of the target product as the captured image of the target product.

### Supplementary Note 9

A classification support method for determining a classification to which a target product belongs from among a plurality of classifications of a predetermined hierarchy in a customs classification number having a hierarchical structure, the method causing a computer to execute:

acquiring a captured image of the target product;

inputting the acquired captured image to a first learned model that is generated for a classification in a higher hierarchy to which the target product belongs among a plurality of classifications included in a higher hierarchy positioned higher than the predetermined hierarchy, and outputs classification information to which a product relevant to the input captured image in the predetermined hierarchy belongs in a case where the captured image of the product is input; and

outputting classification information in the predetermined hierarchy relevant to the input captured image from the first learned model.

### Supplementary Note 10

A program for determining a classification to which a target product belongs from among a plurality of classifications of a predetermined hierarchy in a customs classification number having a hierarchical structure, the program causing a computer to execute:

a step of acquiring a captured image of the target product;

a step of inputting the acquired captured image to a first learned model that is generated for a classification in a higher hierarchy to which the target product belongs among a plurality of classifications included in a higher hierarchy positioned higher than the predetermined hierarchy, and outputs classification information to which a product relevant to the input captured image in the predetermined hierarchy belongs in a case where the captured image of the product is input; and

a step of outputting classification information in the predetermined hierarchy relevant to the input captured image from the first learned model.

### Supplementary Note 11

A learning model generation method including:

acquiring teacher data including a captured image of a product and classification information to which the product belongs in a predetermined

hierarchy of a customs classification number having a hierarchical structure; and

generating a learning model that outputs classification information to which the product belongs in a case where a captured image of the product is input based on the teacher data.

### Supplementary Note 12

A learned model for causing a computer to function as:

an input layer to which a captured image of a product is input;

an output layer that outputs classification information to which the product belongs in a predetermined hierarchy in a customs classification number having a hierarchical structure; and

an intermediate layer in which a parameter is learned by using teacher data to which a captured image of the product is input and classification information to which the product belongs is output, in which

the captured image of the product is input, calculation is performed in the intermediate layer, and classification information to which the product belongs is output from the output layer.

Some or all of the elements (such as configurations and functions, for example) described in Supplementary Notes 2 to 8 dependent on Supplementary Note 1may be dependent on Supplementary Notes 9 to 12 as well with dependent relationships similar to those of Supplementary Notes 2 to 8. Some or all of the elements described in any supplementary note may be applied to various types of hardware, software, recording means for recording software, systems, and methods.

The present disclosure is not limited to the above-described example embodiments, and can be appropriately modified without departing from the scope. For example, the present disclosure is not limited to a customs classification number. The present disclosure can be applied to other numbers and codes for classifying products and having a hierarchical structure.

1. A classification support system that determines a classification to which a target product belongs from among a plurality of classifications of a predetermined hierarchy in a customs classification number having a hierarchical structure, the classification support system comprising:
at least one memory storing instructions, and
at least one processor configured to execute the instructions to;
acquire a captured image of the target product;
input the acquired captured image to a first learned model that outputs classification information to which a product relevant to the input captured image belongs in the predetermined hierarchy in a case where a captured image of the product is input; and
output classification information in the predetermined hierarchy relevant to the input captured image from the first learned model, wherein
the first learned model is generated for each of a plurality of classifications included in a higher hierarchy positioned higher than the predetermined hierarchy, and
the at least one processor is configured to execute the instructions to input the captured image to the first learned model generated for a classification in the higher hierarchy to which the target product belongs.

2. The classification support system according to claim 1, wherein
the first learned model outputs text information describing a product relevant to the input captured image as the classification information, and
the at least one processor is further configured to execute the instructions to output the text information as classification information in the predetermined hierarchy relevant to the input captured image.

3. The classification support system according to claim 2, wherein the at least one processor is further configured to execute the instructions to output the text information as the classification information in a case where a certainty factor of classification in the predetermined hierarchy relevant to the captured image is less than a predetermined threshold.

4. The classification support system according to claim 2, wherein the at least one processor is further configured to execute the instructions to:
input the text information that is output to a second learned model that outputs a customs classification number for a product in a case where text information describing the product is input; and
output, from the second learned model, a customs classification number relevant to the input text information.

5. The classification support system according to claim 4, wherein
the at least one processor is further configured to execute the instructions to acquire invoice information of the target product, and
the second learned model outputs a customs classification number for a product in a case where text information describing the product that is included in the invoice information is input.

6. The classification support system according to claim 1, wherein the at least one processor is further configured to execute the instructions to;
store a master image in which a target product of which a classification of the predetermined hierarchy is determined appears, and a classification of a higher hierarchy of the target product and a classification of the predetermined hierarchy in association with each other;
further input the master image to the first learned model that outputs classification information of the predetermined hierarchy of the target product by determining similarity between the acquired captured image and the master image belonging to a classification of a higher hierarchy of the target product appearing in the captured image; and
output classification information of the predetermined hierarchy relevant to the input captured image and the master image.

7. The classification support system according to claim 1, wherein the first learned model is generated for each classification included in a hierarchy one level higher than the predetermined hierarchy for which the classification is to be determined.

8. The classification support system according to claim 1, wherein the at least one processor is further configured to execute the instructions to acquire at least a front view, a side view, and a top view of the target product as the captured image of the target product.

9. A classification support method for determining a classification to which a target product belongs from among a plurality of classifications of a predetermined hierarchy in a customs classification number having a hierarchical structure, the method causing a computer to execute:
acquiring a captured image of the target product;
inputting the acquired captured image to a first learned model that is generated for a classification in a higher hierarchy to which the target product belongs among a plurality of classifications included in a higher hierarchy positioned higher than the predetermined hierarchy, and outputs classification information to which a product relevant to the input captured image belongs in the predetermined hierarchy in a case where a captured image of the product is input; and
outputting classification information in the predetermined hierarchy relevant to the input captured image from the first learned model.

10. A non-transitory computer-readable medium storing a program for determining a classification to which a target product belongs from among a plurality of classifications of a predetermined hierarchy in a customs classification number having a hierarchical structure, the program causing a computer to execute:
a step of acquiring a captured image of the target product;
a step of inputting the acquired captured image to a first learned model that is generated for a classification in a higher hierarchy to which the target product belongs among a plurality of classifications included in a higher hierarchy positioned higher than the predetermined hierarchy, and outputs classification information to which a product relevant to the input captured image belongs in the predetermined hierarchy in a case where a captured image of the product is input; and
a step of outputting classification information in the predetermined hierarchy relevant to the input captured image from the first learned model.
